(19) United States
(12) Patent Application Publication
(10) Pub. No.: US 2013/0229491 A1
(43) Pub. Date: Sep. 5, 2013

(54) METHOD OF OPERATING A THREE-DIMENSIONAL IMAGE SENSOR

(71) Applicant: SAMSUNG ELECTRONICS CO., LTD., Suwon-si (KR)

(72) Inventors: Wang-Hyun KIM, Namyangju-si (KR); Dong-Ki MIN, Seoul (KR); Young-Gu JIN, Osan-si (KR); Ilia OVSIANNIKOV, Pasadena, CA (US)

(73) Assignee: SAMSUNG ELECTRONICS CO., LTD., Suwon-Si (KR)

(21) Appl. No.: 13/743,595

(22) Filed: Jan. 17, 2013

(30) Foreign Application Priority Data
Mar. 2, 2012 (KR) 10-2012-0021785

(51) Int. Cl. G06F 3/01

(52) U.S. Cl. CPC G06F 3/017
USPC 348/46

(57) ABSTRACT

In a method of operating a three-dimensional image sensor including a light source module according to example embodiments, the three-dimensional image sensor detects a position change of an object by generating a two-dimensional image in a low power standby mode. The three-dimensional image sensor switches a mode from the low power standby mode to a three-dimensional operating mode when the position change of the object is detected in the two-dimensional image. The three-dimensional image sensor performs gesture recognition for the object by generating a three-dimensional image using the light source module in the three-dimensional operating mode.

### CROSS-REFERENCE TO RELATED APPLICATIONS

This U.S. non-provisional application claims the benefit of priority under 35 U.S.C. §119 to Korean Patent Application No. 2012-0021785 filed on Mar. 2, 2012 in the Korean Intellectual Property Office (KIPO), the entire content of which is incorporated herein by reference in its entirety.

### BACKGROUND

1. Technical Field

Example embodiments relate to image sensors. More particularly, example embodiments relate to methods of operating three-dimensional image sensors including a plurality of depth pixels.

2. Description of the Related Art

An image sensor is a photo-detection device that converts optical signals including image and/or distance (i.e., depth) information of an object into electrical signals. Various types of image sensors, such as charge-coupled device (CCD) image sensors, CMOS image sensors (CIS), etc., have been developed to provide high quality image information of the object. Recently, a three-dimensional (3D) image sensor is being researched and developed which provides depth information as well as two-dimensional image information.

The three-dimensional image sensor can be used to perform motion recognition or gesture recognition. However, since the three-dimensional image sensor consumes large power during the gesture recognition, portable devices supplied with power by a battery, such as a smart phone, a tablet computer, etc., cannot afford to employ the three-dimensional image sensor because of the power consumption.

### SUMMARY

Some example embodiments provide a method of operating a three-dimensional image sensor capable of reducing power consumption.

According to example embodiments, in a method of operating a three-dimensional image sensor including a light source module, the three-dimensional image sensor detects a position change of an object by generating a two-dimensional image in a low power standby mode, a mode of the three-dimensional image sensor is switched from the low power standby mode to a three-dimensional operating mode when the position change of the object is detected in the two-dimensional image, and the three-dimensional image sensor performs gesture recognition for the object by generating a three-dimensional image using the light source module in the three-dimensional operating mode.

In some example embodiments, the light source module may be configured to be deactivated in the low power standby mode, and is configured to be activated in the three-dimensional operating mode.

In some example embodiments, the light source module may be configured to emit light with relatively low luminance in the low power standby mode, and may be configured to emit the light with relatively high luminance in the three-dimensional operating mode.

In some example embodiments, the light emitted by light source module may be infrared light or near-infrared light.

In some example embodiments, the gesture recognition may be performed by measuring a distance of the object from the three-dimensional image sensor and a horizontal movement of the object.

In some example embodiments, the distance of the object from the three-dimensional image sensor may be measured based on a time-of-flight of light that is emitted by the light source module and is reflected by the object back to the three-dimensional image sensor, the time-of-flight being an amount of time between transmission of the emitted light and receipt of the emitted light at the three-dimensional sensor after the emitted light is reflected from the object.

In some example embodiments, the three-dimensional image sensor may include a plurality of depth pixels.

In some example embodiments, the three-dimensional image sensor may include a plurality of color pixels and a plurality of depth pixels. The three-dimensional image sensor may be configured to generate the two-dimensional image using the plurality of color pixels in the low power standby mode, and may be configured to generate the three-dimensional image using the plurality of depth pixels in the three-dimensional operating mode.

In some example embodiments, the three-dimensional image sensor may include a plurality of depth pixels. The three-dimensional image sensor may be configured to group the plurality of depth pixels into a plurality of pixel groups, and may be configured to generate the two-dimensional image based on output signals of the plurality of pixel groups.

In some example embodiments, sizes of the plurality of pixel groups may be determined according to distances of the plurality of pixel groups from a center of a field of view of the three-dimensional image sensor, and a number of the depth pixels included in each pixel group may increase as a distance of the pixel group from the center of the field of view increases.

In some example embodiments, the three-dimensional image sensor may include a plurality of depth pixels arranged in a matrix form having a plurality of rows and a plurality of columns, and the three-dimensional image sensor may be configured to generate the two-dimensional image using the depth pixels in a portion of the plurality of rows.

According to example embodiments, in a method of operating a three-dimensional image sensor including a light source module, the three-dimensional image sensor detects a position change of an object by generating a two-dimensional image in a low power standby mode, a mode of the three-dimensional image sensor is switched from the low power standby mode to a three-dimensional operating mode when the position change of the object is detected in the two-dimensional image, the three-dimensional image sensor performs gesture recognition for the object by generating a three-dimensional image using the light source module in the three-dimensional operating mode, and the mode of the three-dimensional image sensor is switched from the three-dimensional operating mode to the low power standby mode after the gesture recognition is completed.

In some example embodiments, an integration time for generating the two-dimensional image in the low power standby mode may be longer than an integration time for generating the three-dimensional image in the three-dimensional operating mode.

In some example embodiments, the three-dimensional image sensor may use light of low luminance emitted by the light source module or ambient light to generate the two-dimensional image in the low power standby mode.

In some example embodiments, if the position change of the object is not detected, the mode of the three-dimensional image sensor may be maintained as the low power standby mode.

According to some example embodiments, a method of operating a three-dimensional image sensor may include detecting a change in a position of an object based on a two-dimensional image of the object captured by the three-dimensional image sensor operating in a low-power mode; changing the low-power mode of the three dimensional image sensor to a high power mode based on the detecting, the high-power mode using more power than the low-power mode; and performing three-dimensional gesture recognition based on a three-dimensional image of the object captured by the three-dimensional sensor operating in the high-powered mode.

Changing the low-power mode to the high-power mode may include activating a light source module which emits light on the object when activated.

The method may further include changing the high-power mode to the low-power mode after movement of the object is no longer detected by the three-dimensional sensor.

Changing the high-power mode to the low-power mode may include deactivating a light source module which emits light on the object when activated.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a flow chart illustrating a method of operating a three-dimensional image sensor according to example embodiments.

FIG. 2 is a block diagram illustrating a three-dimensional image sensor according to example embodiments.

FIG. 3 is a diagram for describing an example of measuring a distance of an object according to the method of FIG. 2.

FIG. 4 is a flow chart illustrating a method of operating a three-dimensional image sensor according to example embodiments.

FIG. 5 is a flow chart illustrating an example of a method of operating a three-dimensional image sensor illustrated in FIG. 4.

FIGS. 6A through 6D are diagrams for describing an example of an operation of a three-dimensional image sensor according to example embodiments.

FIG. 7 is a diagram for describing an exemplary operation of a plurality of depth pixels included in a three-dimensional image sensor according to example embodiments.

FIG. 8 is a diagram for describing another exemplary operation of a plurality of depth pixels included in a three-dimensional image sensor according to example embodiments.

FIG. 9 is a diagram illustrating an example of a pixel array included in a three-dimensional image sensor according to example embodiments.

FIG. 10 is a block diagram illustrating a camera including a three-dimensional image sensor according to example embodiments.

FIG. 11 is a block diagram illustrating a computing system including a three-dimensional image sensor according to example embodiments.

### DETAILED DESCRIPTION OF THE EMBODIMENTS

Various example embodiments will be described more fully hereinafter with reference to the accompanying drawings, in which some example embodiments are shown. Example embodiments may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

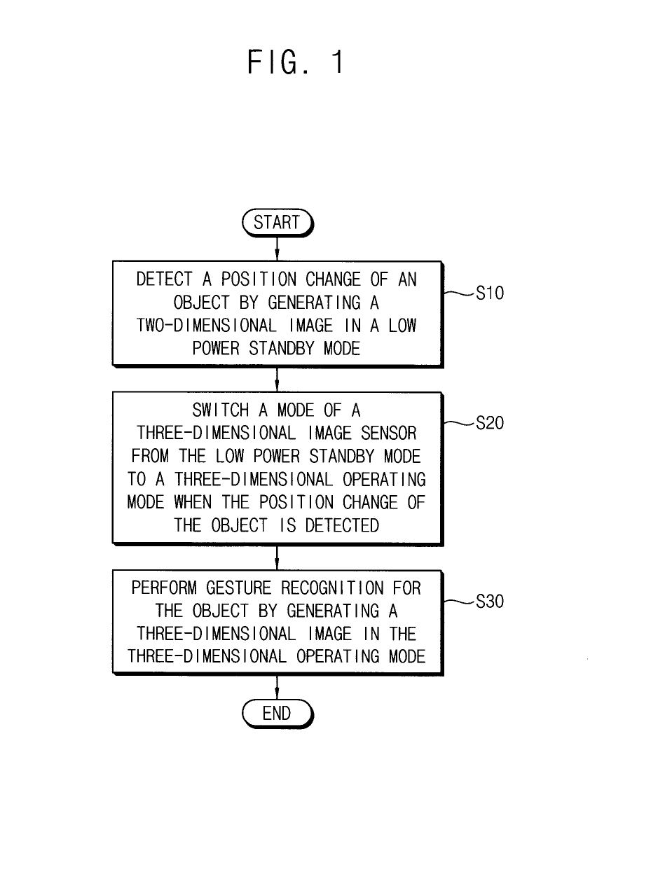

FIG. 1 is a flow chart illustrating a method of operating a three-dimensional image sensor according to example embodiments.

Referring to FIG. 1, in a method of operating a three-dimensional image sensor including a light source module, the three-dimensional image sensor detects a position change of an object by generating a two-dimensional image in a low power standby mode (S10). The three-dimensional image sensor may operate in the low power standby mode while the object does not move or during a standby state. In some example embodiments, the light source module may be deactivated in the low power standby mode. In other example embodiments, the light source module may emit light with low luminance in the low power standby mode. The light emitted by the light source module may be infrared light or near-infrared light. A conventional three-dimensional image sensor typically consumes large power. However, since the light source module is deactivated or the light source module emits the light with low luminance while the three-dimensional image sensor does not perform gesture recognition, the three-dimensional image sensor according to example embodiments may reduce power consumption.

In the low power standby mode, the three-dimensional image sensor may perform not a three-dimensional image sensing operation but a two-dimensional image sensing operation. That is, the three-dimensional image sensor may generate the two-dimensional image to detect the position change of the object in the low power standby mode. In some example embodiments, an integration time for generating the two-dimensional image may be longer than an integration time for generating the three-dimensional image. Since the integration time during which the three-dimensional image sensor receives light to generate the two-dimensional image is sufficiently long, the three-dimensional image sensor is able to generate the two-dimensional image by using the light of low luminance emitted by the light source module or ambient light. Accordingly, the light source module may be deactivated or may consume less power in the low power standby mode, and thus the three-dimensional image sensor may reduce power consumption.

As described above, the three-dimensional image sensor may capture two-dimensional images by using relatively long integration times. For example, a one-tap three-dimensional image sensor may capture four frames of two-dimensional images to obtain one frame of a three-dimensional image. If the one-tap three-dimensional image sensor outputs the two-dimensional image in a two-dimensional mode (e.g., the low power standby mode) and the three-dimensional image in a three-dimensional mode (e.g., a three-dimensional operating mode) with the same frames per second (FPS), the integration time required to generate the two-dimensional image in the two-dimensional mode may be four times longer than the integration time required to generate each two-dimensional image for obtaining the three-dimensional image in the three-dimensional mode. Further, a two-tap three-dimensional image sensor may capture two frames of two-dimensional images to obtain one frame of a three-dimensional image. If the two-tap three-dimensional image sensor outputs the two-dimensional image in the two-dimensional mode and the three-dimensional image in the three-dimensional mode with the same FPS, the integration time required to generate the two-dimensional image in the two-dimensional mode may be two times longer than the integration time required to generate each two-dimensional image for obtaining the three-dimensional image in the three-dimensional mode. For example, in a case where the three-dimensional image sensor operations in 30 FPS, and four frames of the two-dimensional images are captured per frame of the three-dimensional image in the three-dimensional mode, the integration time of the three-dimensional mode may be about 1 /(30*4) sec, or about 8.3 ms, and the integration time of the two-dimensional mode, or the low power standby mode may be about 1/30 sec, or about 33.3 ms.

In the low power standby mode, the three-dimensional image sensor may generate two-dimensional images with a predetermined FPS, and may detect the position change of the object by comparing consecutive two-dimensional images. If a position of the object in a two-dimensional image is different from a position of the object in a subsequent two-dimensional image, the three-dimensional image sensor may decide that the object moves and changes the position.

Referring again to FIG. 1, the three-dimensional image sensor switches a mode from the low power standby mode to a three-dimensional operating mode when the position change of the object is detected in the two-dimensional image (S20). Power consumption of the three-dimensional image sensor in the three-dimensional operating mode may be greater than power consumption in the low power standby mode. According to example embodiments, in the three-dimensional operating mode, the light source module may be activated, or may emit light with high luminance.

In the three-dimensional operating mode, the three-dimensional image sensor performs gesture recognition for the object by generating a three-dimensional image using the light source module (S30). The gesture recognition may be performed by measuring a distance (or depth) of the object from the three-dimensional image sensor and a horizontal movement of the object. For example, in a case where the three-dimensional image sensor employed in an electronic book (E-book), the three-dimensional image sensor may detect a horizontal movement of a hand of a user when the user performs an action, such as flipping or turning E-book pages. In a case where the three-dimensional image sensor included in a video game machine, the three-dimensional image sensor may measure a distance of a user from the video game machine when the user approaches or recedes from the video game machine.

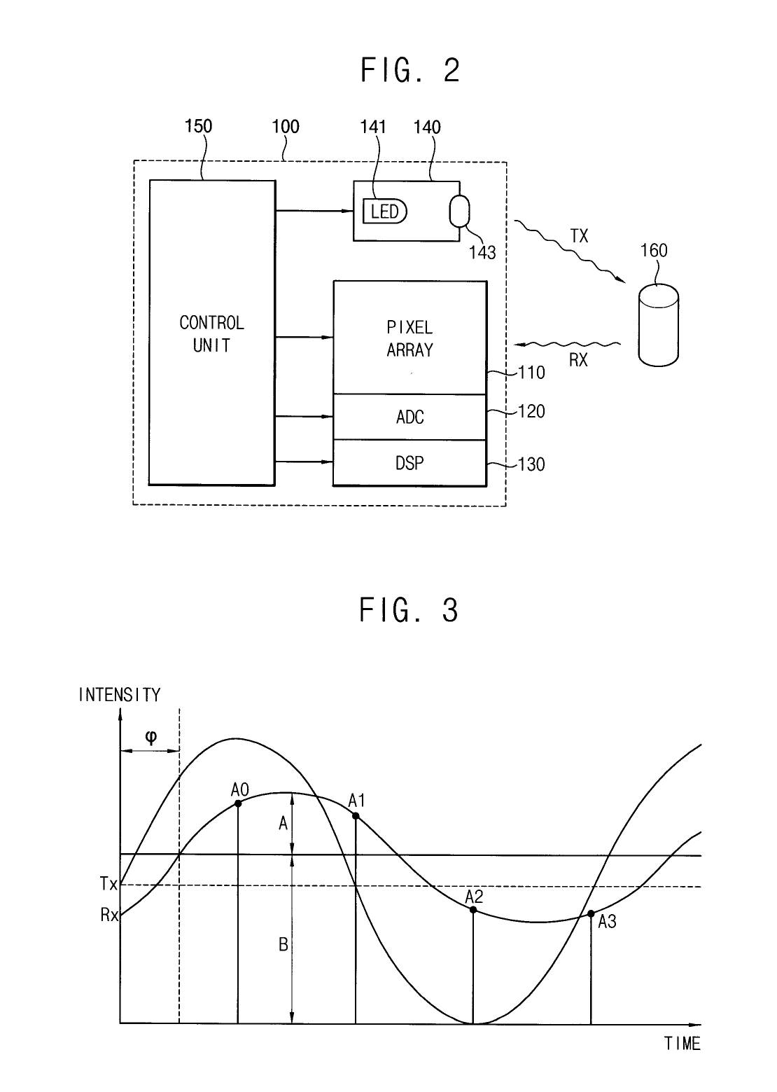

The horizontal movement of the object may be measured by comparing consecutive three-dimensional images. Here, the horizontal movement of the object may include movements in right, left, up and/or down directions that are perpendicular to a line connecting the three-dimensional image sensor and the object. The distance of the object from the three-dimensional image sensor may be measured based on a time-of-flight of the light that is emitted by the light source module and is reflected by the object back to the three-dimensional image sensor. The measurement of the distance will be described below with reference to FIGS. 2 and 3.

FIG. 2 is a block diagram illustrating a three-dimensional image sensor according to example embodiments.

Referring to FIG. 2, a three-dimensional image sensor 100 includes a pixel array 110, an analog-to-digital conversion (ADC) unit 120, a digital signal processing (DSP) unit 130, a light source module 140 and a control unit 150.

The pixel array 110 may include depth pixels receiving light RX that is reflected from an object 160 after being emitted to the object 160 by the light source module 140. The depth pixels may convert the received light RX into electrical signals. The depth pixels may provide information about a distance (or depth) of the object 160 from the three-dimensional image sensor 100 (i.e. depth information) and/or black-and-white image information. In some example embodiments, the three-dimensional image sensor 100 may use infrared light or near-infrared light of low luminance emitted by the light source module 140 to generate a two-dimensional image in a low power standby mode. In other example embodiments, the three-dimensional image sensor 100 may use infrared light or near-infrared light included in ambient light to generate the two-dimensional image in the low power standby mode.

The pixel array 110 may further include color pixels for providing color image information. In this case, the three-dimensional image sensor 100 may be a three-dimensional color image sensor that provides the color image information and the depth information. In some example embodiments, an infrared filter and/or a near-infrared filter may be formed on the depth pixels, and a color filter (e.g., red, green and blue filters) may be formed on the color pixels. According to example embodiments, a ratio of the number of the depth pixels to the number of the color pixels may vary as desired. In some example embodiments, three-dimensional image sensor 100 may generate the two-dimensional image using the color pixels in the low power standby mode, and may generate a three-dimensional image using the depth pixels in a three-dimensional operating mode.

The ADC unit 120 may convert an analog signal output from the pixel array 110 into a digital signal. In some example embodiments, the ADC unit 120 may perform a column analog-to-digital conversion that converts analog signals in parallel using a plurality of analog-to-digital converters respectively coupled to a plurality of column lines. In other example embodiments, the ADC unit 120 may perform a single analog-to-digital conversion that sequentially converts the analog signals using a single analog-to-digital converter.

According to example embodiments, the ADC unit 120 may further include a correlated double sampling (CDS) unit for extracting an effective signal component. In some example embodiments, the CDS unit may perform an analog double sampling that extracts the effective signal component based on a difference between an analog reset signal including a reset component and an analog data signal including a signal component. In other example embodiments, the CDS unit may perform a digital double sampling that converts the analog reset signal and the analog data signal into two digital signals and extracts the effective signal component based on a difference between the two digital signals. In still other example embodiments, the CDS unit may perform a dual correlated double sampling that performs both the analog double sampling and the digital double sampling.

The DSP unit 130 may receive a digital image signal output from the ADC unit 120, and may perform image data processing on the digital image signal. For example, the DSP unit 130 may perform image interpolation, color correction, white balance, gamma correction, color conversion, etc.

The light source module 140 may emit light TX of a desired (or, alternatively predetermined) wavelength. For example, the light source module 140 may emit infrared light and/or near-infrared light. The light source module 140 may include a light source 141 and a lens 143. The light source 141 may be controlled by the control unit 150 to emit the light TX that is modulated to have substantially periodic intensity. For example, the intensity of the emitted light TX may be modulated to have a waveform of a pulse wave, a sine wave, a cosine wave, or the like. The light source 141 may be implemented by a light emitting diode (LED), a laser diode, or the like. The lens 143 may focus the light TX emitted by the light source 141 on the object 160. In some example embodiments, the light source module 140 may emit light of different luminance according to a mode of the three-dimensional image sensor 100. For example, the light source module 140 may emit light TX with low luminance in the low power standby mode, and may emit light TX with high luminance in the three-dimensional operating mode. In other example embodiments, the light source module 140 may be deactivated in the low power standby mode, and may be activated in the three-dimensional operating mode.

The control unit 150 may control the pixel array 110, the ADC unit 120, the DSP unit 130 and the light source module 140. The control unit 150 may provide the pixel array 110, the ADC unit 120, the DSP unit 130 and the light source module 140 with control signals, such as a clock signal, a timing control signal, or the like. According to example embodiments, the control unit 150 may include a control logic circuit, a phase locked loop circuit, a timing control circuit, a communication interface circuit, or the like.

Although not illustrated in FIG. 2, according to example embodiments, the three-dimensional image sensor 100 may further include a row decoder that selects a row line of the pixel array 110, and a row driver that activates the selected row line. According to example embodiments, the three-dimensional image sensor 100 may further include a column decoder that selects one of a plurality of analog-to-digital converters included in the ADC unit 120, and a column driver that provides an output of the selected analog-to-digital converter to the DSP unit 130 or an external host (not shown).

Hereinafter, an operation of the three-dimensional image sensor 100 according to example embodiments will be described below.

The control unit 150 may control the light source module 140 to emit the light TX modulated to have substantially periodic intensity. In some example embodiments, the light source module 140 may emit light TX with low luminance to the object 160 in the low power standby mode. In other example embodiments, in the low power standby mode, the light source module 140 may be deactivated, and the three-dimensional image sensor 100 may use the ambient light to generate the two-dimensional image. The emitted light TX may be reflected by the object 160 back to the three-dimensional image sensor 100, and may be incident on the depth pixels included in the pixel array 110 as the received light RX. The ADC unit 120 may convert analog signals output from the depth pixels into digital signals. The DSP unit 130 may generate pixel outputs based on the digital signals, and may provide the pixel outputs to the control unit 150 and/or the external host. The pixel outputs may correspond to the two-dimensional image. The control unit 150 may detect a position change of the object 100 based on the two-dimensional image.

Once the position change of the object 160 is detected, the control unit 150 may control the light source module 140 to emit the light TX with high luminance. The control unit 150 may perform gesture recognition for the object 160 by analyzing the received light RX that is reflected by the object 160 back to the three-dimensional image sensor 100 and is incident on the depth pixels.

As described above, the three-dimensional image sensor 100 according to example embodiments may generate the two-dimensional image with low power consumption in the low power standby mode, and may switch the mode to the three-dimensional operating mode when the position change of the object 160 is detected in the two-dimensional image. The three-dimensional image sensor 100 may perform the gesture recognition for the object 160 by using the light TX of high luminance in the three-dimensional operating mode. Accordingly, the three-dimensional image sensor 100 may reduce the power consumption.

FIG. 3 is a diagram for describing an example of measuring a distance of an object according to the method of FIG. 2.

Referring to FIGS. 2 and 3, light TX emitted by a light source module 140 may have a periodic intensity and/or characteristic. For example, the intensity (for example, the number of photons per unit area) of the light TX may have a waveform of a sine wave.

The light TX emitted by the light source module 140 may be reflected by the object 160, and then may be incident on the pixel array 110 as received light RX. The pixel array 100 may periodically sample the received light RX. According to example embodiments, during each period of the received light RX (for example, corresponding to a period of the transmitted light TX), the pixel array 100 may perform a sampling on the received light RX by sampling, for example, at two sampling points having a phase difference of about 180 degrees, at four sampling points having a phase difference of about 90 degrees, or at more than four sampling points. For example, the pixel array 110 may extract four samples A0, A1, A2 and A3 of the received light RX at phases of about 90 degrees, about 180 degrees, about 270 degrees and about 360 degrees per period, respectively.

The received light RX may have an offset B that is different from an offset of the light TX emitted by the light source module 140 due to background light, a noise, or the like. The offset B of the received light RX may be calculated by Equation 1.

$$B = \frac{A 0 + A 1 + A 2 + A 3}{4} \qquad [ Equation 1 ]$$

Here, A0 represents an intensity of the received light RX sampled at a phase of about 90 degrees of the emitted light TX, A1 represents an intensity of the received light RX sampled at a phase of about 180 degrees of the emitted light TX, A2 represents an intensity of the received light RX sampled at a phase of about 270 degrees of the emitted light TX, and A3 represents an intensity of the received light RX sampled at a phase of about 360 degrees of the emitted light TX.

The received light RX may have an amplitude A lower than that of the light TX emitted by the light source module 140 due to loss (for example, light loss). The amplitude A of the received light RX may be calculated by Equation 2.

$$A = \frac{\sqrt{{( A 0 - A 2 )}^{2} + {( A 1 - A 3 )}^{2}}}{2} \qquad [ Equation 2 ]$$

Black-and-white image information about the object 160, or the two-dimensional image may be provided by respective depth pixels included in the pixel array 110 based on the amplitude A of the received light RX.

The received light RX may be delayed by a phase difference Φ corresponding, for example, to a double of the distance of the object 160 from the three-dimensional image sensor 100 with respect to the emitted light TX. The phase difference Φ between the emitted light TX and the received light RX may be calculated by Equation 3.

$$φ = arctan ( \frac{A 0 - A 2}{A 1 - A 3} ) \qquad [ Equation 3 ]$$

The phase difference Φ between the emitted light TX and the received light RX may, for example, correspond to a time-of-flight (TOF), which may represent an amount of time between the transmission of the light from the light source module 140 and receipt of the reflected light back at the image sensor 100. The distance of the object 160 from the three-dimensional image sensor 100 may be calculated by an equation, “R=c*TOF/2”, where R represents the distance of the object 160, and c represents the speed of light. Further, the distance of the object 160 from the three-dimensional image sensor 100 may also be calculated by Equation 4 using the phase difference Φ between the emitted light TX and the received light RX.

$$R = \frac{c}{4 π f} φ \qquad [ Equation 4 ]$$

Here, f represents a modulation frequency, which is a frequency of the intensity of the emitted light TX (or a frequency of the intensity of the received light RX).

As described above, the three-dimensional image sensor 100 according to example embodiments may obtain depth information about the object 160 using the light TX emitted by the light source module 140. Although FIG. 2 illustrates the light TX of which the intensity has a waveform of a sine wave, the three-dimensional image sensor 100 may use the light TX of which the intensity has various types of waveforms, according to example embodiments. Further, the three-dimensional image sensor 100 may extract the depth information in various manners according to the waveform of the intensity of the light TX, a structure of a depth pixel, or the like.

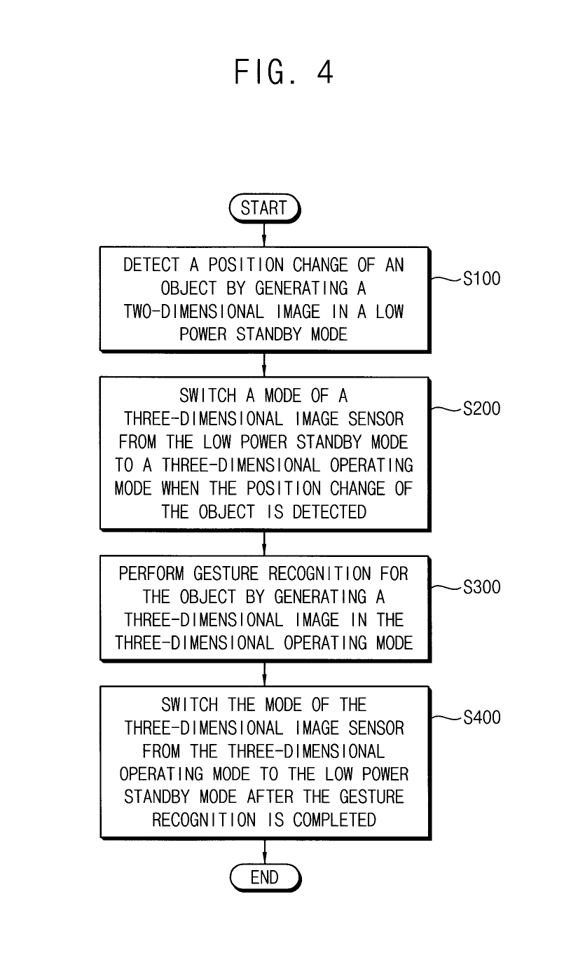

FIG. 4 is a flow chart illustrating a method of operating a three-dimensional image sensor according to example embodiments.

Referring to FIG. 4, in a method of operating a three-dimensional image sensor, the three-dimensional image sensor detects a position change of an object by generating a two-dimensional image in a low power standby mode (S100). While the object does not move, or during a standby state, the three-dimensional image sensor may operate in the low power standby mode. According to example embodiments, in the low power standby mode, the three-dimensional image sensor may be deactivated, or may emit light with luminance. The three-dimensional image sensor may generate the two-dimensional image using the light of low luminance emitted by the light source module or ambient light, and may detect the position change of the object in the generated two-dimensional image.

The three-dimensional image sensor switches a mode from the low power standby mode to a three-dimensional operating mode when the position change of the object is detected in the two-dimensional image (S20). Power consumption of the three-dimensional image sensor in the three-dimensional operating mode may be greater than power consumption in the low power standby mode. According to example embodiments, in the three-dimensional operating mode, the light source module may be activated, or may emit light with high luminance. If the position change of the object is not detected in the two-dimensional image, the three-dimensional image sensor may maintain the low power standby mode.

In the three-dimensional operating mode, the three-dimensional image sensor performs gesture recognition for the object by generating a three-dimensional image using the light source module (S300). The gesture recognition may be performed by measuring a distance of the object from the three-dimensional image sensor and a horizontal movement of the object. In some example embodiments, an integration time for generating the three-dimensional image in the three-dimensional operating mode may be shorter than an integration time for generating the two-dimensional image in the low power standby mode.

After the gesture recognition is completed, the three-dimensional image sensor may switch the mode from the three-dimensional operating mode to the low power standby mode (S400). Since the three-dimensional image sensor switches the mode to the low power standby mode after the gesture recognition, the three-dimensional image sensor may reduce power consumption.

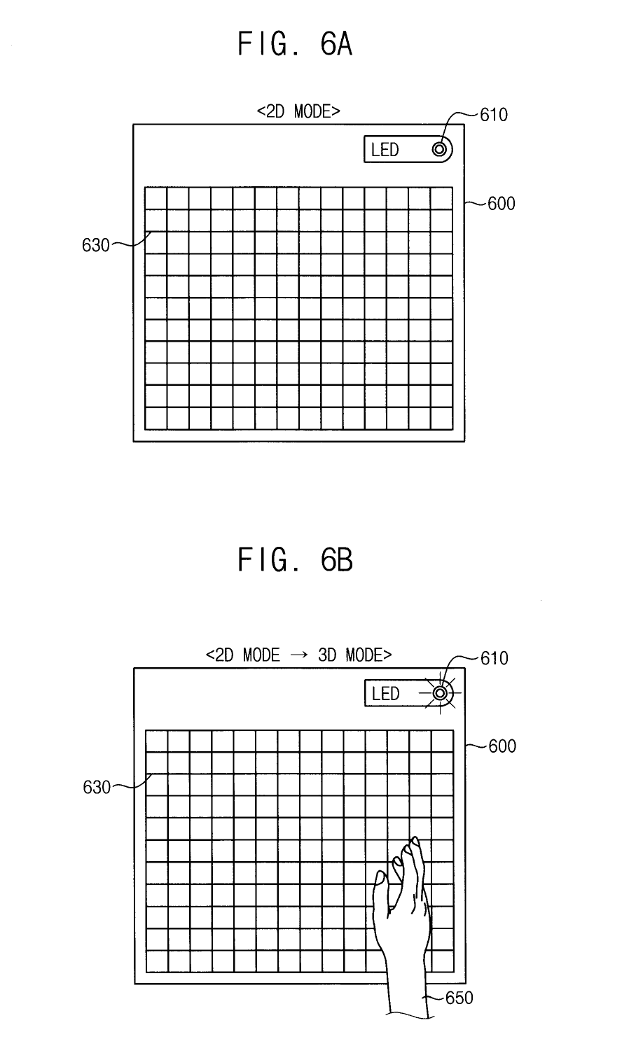

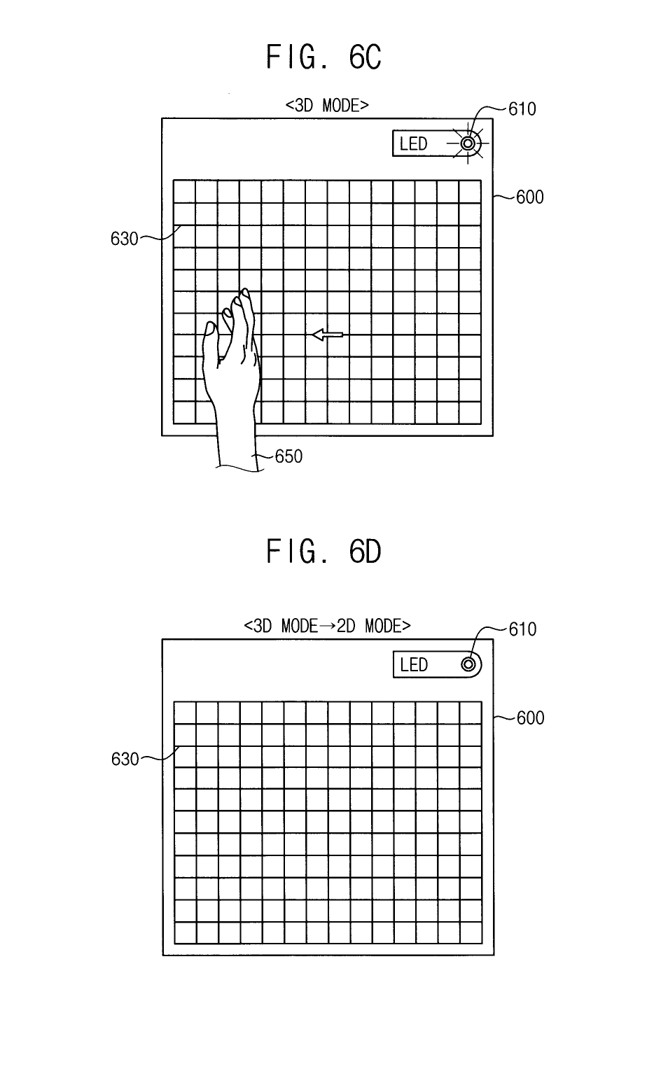

A completion time point of the gesture recognition may be varied according to applications employing the three-dimensional image sensor. For example, in case of an E-book, the gesture recognition may be completed once a user takes an action, such as flipping pages of the E-book by hand. For example, once the hand of the user horizontally moves from one side to the other side, the gesture recognition may be completed. The gesture recognition in the E-book will be described below with reference to FIGS. 6A through 6D. In case of video game machine, the gesture recognition may not be completed even if a single action of the user is completed or the user does not move during a predetermined time period, and the completion time point of the gesture recognition may be dependent on a user setting. For example, the gesture recognition may be completed when the user ends a game session.

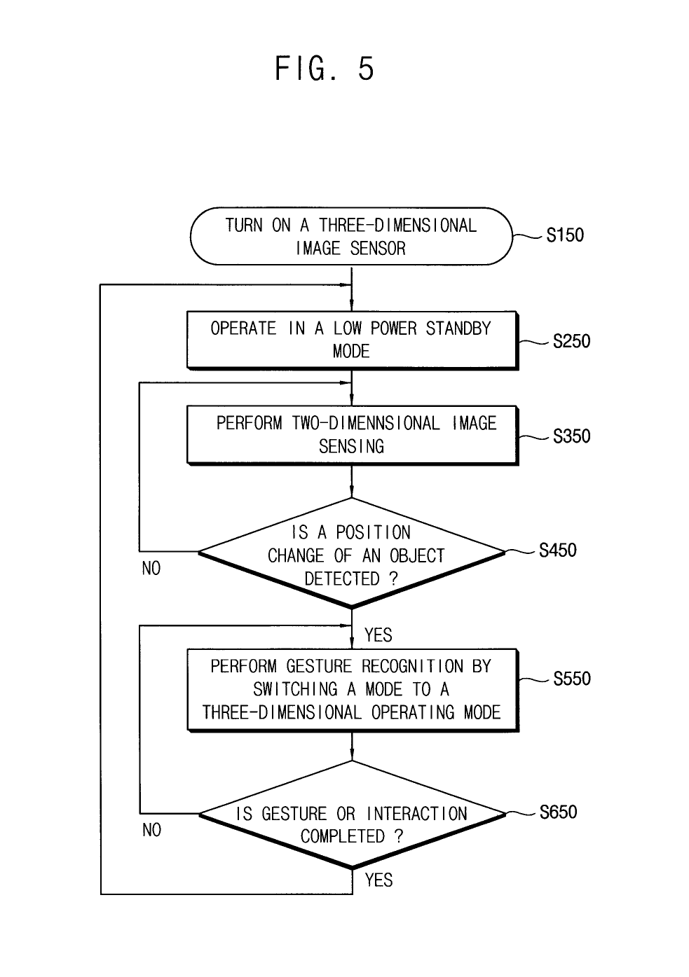

FIG. 5 is a flow chart illustrating an example of a method of operating a three-dimensional image sensor discussed above with reference to FIG. 4.

Referring to FIG. 5, if a three-dimensional image sensor is turned on (S150), the three-dimensional image sensor operates in a low power standby mode (S250). In the low power standby mode, a light source module included in the three-dimensional image sensor may be deactivated, or may emit light with low luminance. The three-dimensional image sensor performs two-dimensional image sensing in the low power standby mode (S350). Since an integration time for generating a two-dimensional image in the low power standby mode is relatively long, the three-dimensional image sensor may generate he two-dimensional image using the light of low luminance. If a position change of an object is not detected in the two-dimensional image (S450: NO), the three-dimensional image sensor continues to perform the two-dimensional image sensing (S350). If the position change of the object is detected in the two-dimensional image (S450: YES), the three-dimensional image sensor switches a mode from the low power standby mode to a three-dimensional operating mode, and performs gesture recognition in the three-dimensional operating mode (S550). The three-dimensional image sensor continues to perform the gesture recognition until a gesture, an interaction or an interactive session is completed (S650: NO, and S550). If the gesture, the interaction or the interactive session is completed (S650: YES), the three-dimensional image sensor returns to the low power standby mode (S250).

FIGS. 6A through 6D are diagrams for describing an example of an operation of a three-dimensional image sensor according to example embodiments. FIGS. 6A through 6D illustrate an example where a three-dimensional image sensor 600 is applied to an E-book.

Referring to FIG. 6A, a three-dimensional image sensor 600 may include a light source module 610 and a plurality of depth pixels 630. The three-dimensional image sensor 600 may operate in a low power standby mode 2D MODE while no object is detected or while an object does not move. In the low power standby mode 2D MODE, a light source mode 610 may be deactivated, or may emit light with low luminance.

Referring to FIG. 6B, when a user puts a hand 650 over the depth pixels 630 to turn pages of the E-book, the depth pixels 630 may detect an object (e.g., the hand 650), and the three-dimensional image sensor 600 may switch a mode from low power standby mode 2D MODE to a three-dimensional operating mode 3D MODE. In the three-dimensional operating mode 3D MODE, the light source module 610 may emit light with high luminance. For example, the three-dimensional image sensor 600 may generate a two-dimensional image using the depth pixels 630 or color pixels in the low power standby mode 2D MODE, and may detect a position change of the hand 650 in the generated two-dimensional image when the hand 650 appears over the depth pixels 630. If the position change of the hand 650 is detected, the three-dimensional image sensor 600 may switch the mode to the three-dimensional operating mode 3D MODE to perform gesture recognition.

Referring to FIG. 6C, the user may move the hand 650 in a horizontal direction to turn the pages of the E-book. The three-dimensional image sensor 600 may generate a three-dimensional image using the depth pixels 630, and may analyze a movement direction of the object (e.g., the hand 650) and a type of gesture based on the generated three-dimensional image. For example, if the hand 650 of the user moves from a right side to a left side, the three-dimensional image sensor 600 determine the action as turning pages of the E-book.

Referring to FIG. 6D, if the hand 650 of the user disappears, the three-dimensional image sensor 600 may determine that the gesture is completed, and may stop to perform the gesture recognition. If the gesture recognition is completed, the three-dimensional image sensor 600 may switch the mode from the three-dimensional operating mode 3D MODE to the low power standby mode 2D MODE, thereby reducing the power consumption.

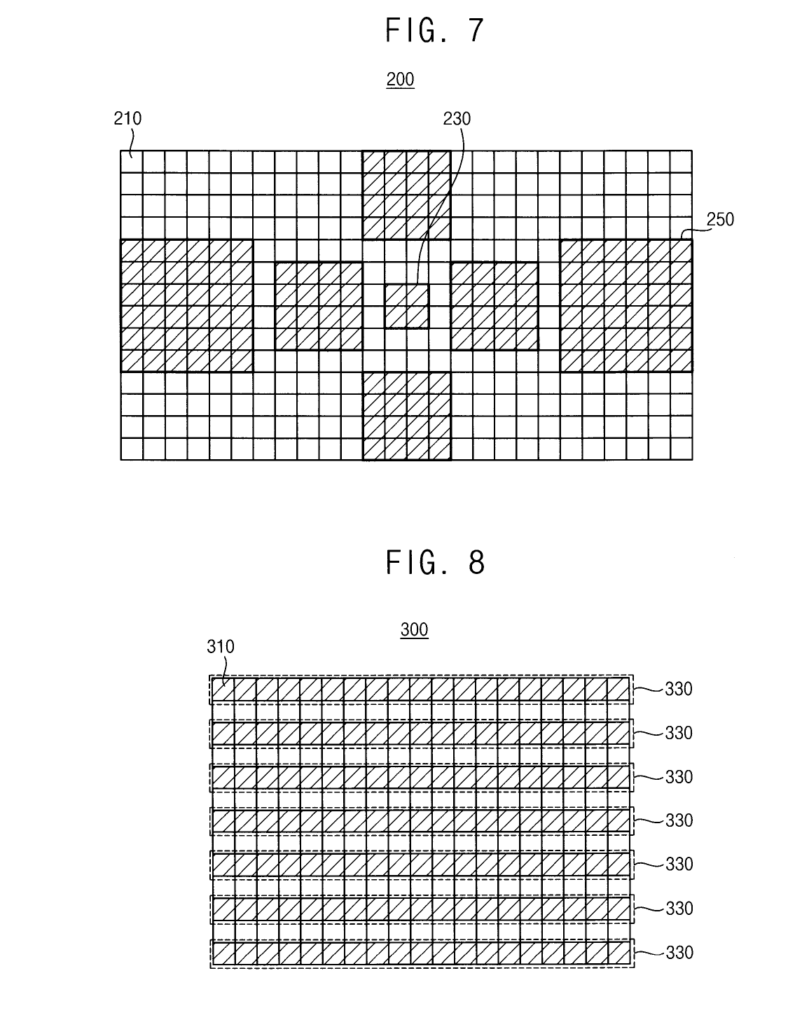

FIG. 7 is a diagram for describing an exemplary operation of a plurality of depth pixels included in a three-dimensional image sensor according to example embodiments.

FIG. 7 illustrates a field of view (FOV) 200 that is divided into a plurality of regions 210. Each region 210 illustrated in FIG. 7 may correspond to one depth pixel included in a pixel array. A plurality of depth pixels may be grouped into a plurality of pixel groups 230 and 250 having sizes determined according to distances from the center of the FOV 200. A three-dimensional image sensor according to example embodiments may generate a two-dimensional image based on pixel group output signals respectively generated by the plurality of pixel groups 230 and 250.

As illustrated in FIG. 7, the plurality of depth pixels may be grouped such that the number of the depth pixels included in each pixel group 230 and 250 increases as the distance from the center of the FOV 200 increases. For example, a first pixel group 230 located at the center of the FOV 200 may include the relatively small number of the depth pixels (e.g., four depth pixels), and a second pixel group 250 located far from the center of the FOV 200 may include relatively large number of the depth pixels (e.g., thirty-six depth pixels). Accordingly, the two-dimensional image generated by the three-dimensional image sensor may have high resolution at a center region of the FOV 200, and may have an improved signal-to-noise ratio (SNR) at a peripheral region of the FOV 200. The three-dimensional image sensor may detect a position change of an object by analyzing the two-dimensional image.

Although FIG. 7 illustrates seven pixel groups for convenience of illustration, according to some embodiments, the plurality of depth pixels may be grouped into various numbers of the pixel groups including more or less than seven pixel groups. Although FIG. 7 illustrates three hundred and sixty-four depth pixels for convenience of illustration, according to some embodiments, the pixel array may include various number of the depth pixels including more or less than three hundred and sixty-four depth pixels. In addition, the pixel array may further include color pixels corresponding to the FOV 200.

The three-dimensional image sensor according to example embodiments may generate the two-dimensional image using light of low luminance with a relatively long integration time in the low power standby mode, and may detect the position change of the object based on the two-dimensional image. Further, the three-dimensional image sensor may use the outputs of the pixel groups to generate the two-dimensional image by grouping the depth pixels, and thus the luminance of the light may be further low. Accordingly, the three-dimensional image sensor may reduce power consumption.

FIG. 8 is a diagram for describing another exemplary operation of a plurality of depth pixels included in a three-dimensional image sensor according to example embodiments.

Referring to FIG. 8, a pixel array 300 of a three-dimensional image sensor may include a plurality of depth pixels 310 that are arranged in a matrix form having a plurality of rows and a plurality of columns. The three-dimensional image sensor may generate a two-dimensional image using the depth pixels 310 in a portion 330 of the plurality of rows. For example, the three-dimensional image sensor may skip the depth pixels 310 in even-numbered rows, and may use the depth pixels 310 in odd-numbered rows 330 to generate the two-dimensional image.

Although FIG. 8 illustrates an example where one row line is skipped between adjacent used row lines, the number of row lines skipped between adjacent used row lines may be varied according to example embodiments. Further, although FIG. 8 illustrates an example of row line skipping, in some example embodiments, column line skipping may be used. In other example embodiments, frame skipping may be used. For example, in a case where the three-dimensional image sensor operates in 60 FPS, the three-dimensional image sensor may generate 30 frames of the two-dimensional image per second.

The three-dimensional image sensor according to example embodiments may generate the two-dimensional image using light of low luminance with a relatively long integration time in a low power standby mode, and may detect a position change of an object based on the two-dimensional image. Further, the three-dimensional image sensor may use a portion of the plurality of depth pixels to generate the two-dimensional image, thereby further reducing power consumption.

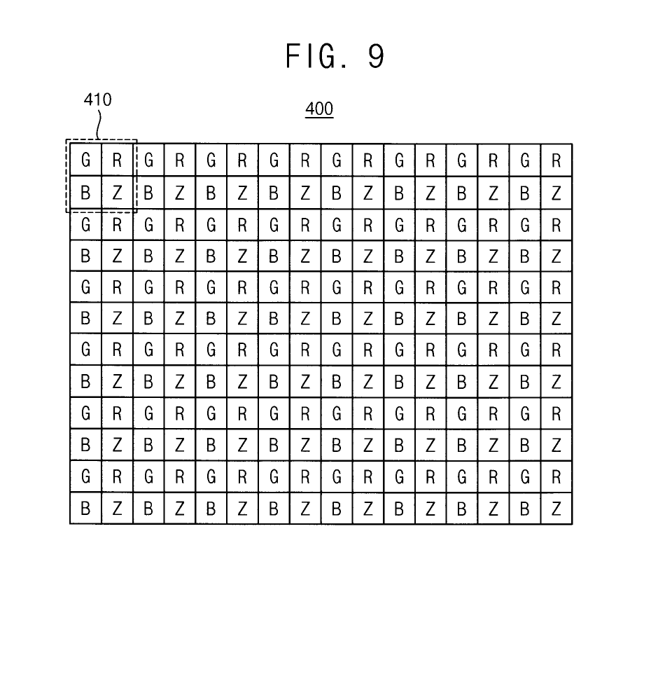

FIG. 9 is a diagram illustrating an example of a pixel array included in a three-dimensional image sensor according to example embodiments. In some example embodiments, as illustrated in FIG. 9, a pixel array 400 may include a plurality of color pixels R, G and B as wells as a plurality of depth pixels Z.

Referring to FIG. 9, the pixel array 400 may include a pixel pattern 410 having the color pixels R, G and B providing color image information and the depth pixel Z providing depth information. The pixel pattern 410 may be repeatedly arranged in the pixel array 410. For example, the color pixels R, G and B may include a red pixel R, a green pixel G and a blue pixel B. According to example embodiments, each of the color pixels R, G and B and the depth pixel Z may include a photodiode, a photo-transistor, a photo-gate, a pinned photo diode (PPD) and/or a combination thereof.

In some example embodiments, color filters may be formed on the color pixels R, G and B, and an infrared filter (or a near-infrared filter) may be formed on the depth pixel Z. For example, a red filter may be formed on the red pixel R, a green filter may be formed on the green pixel G, a blue filter may be foimed on the blue pixel B, and an infrared (or near-infrared) pass filter may be formed on the depth pixel Z. In some example embodiments, an infrared (or near-infrared) cut filter may be further formed on the color pixels R, G and B.

The three-dimensional image sensor according to example embodiments may generate a two-dimensional image using the plurality of color pixels R, G and B in a low power standby mode, and may generate a three-dimensional image using the plurality of depth pixels Z in a three-dimensional operating mode. In this case, the three-dimensional image sensor may deactivate a light source module in the low power standby mode.

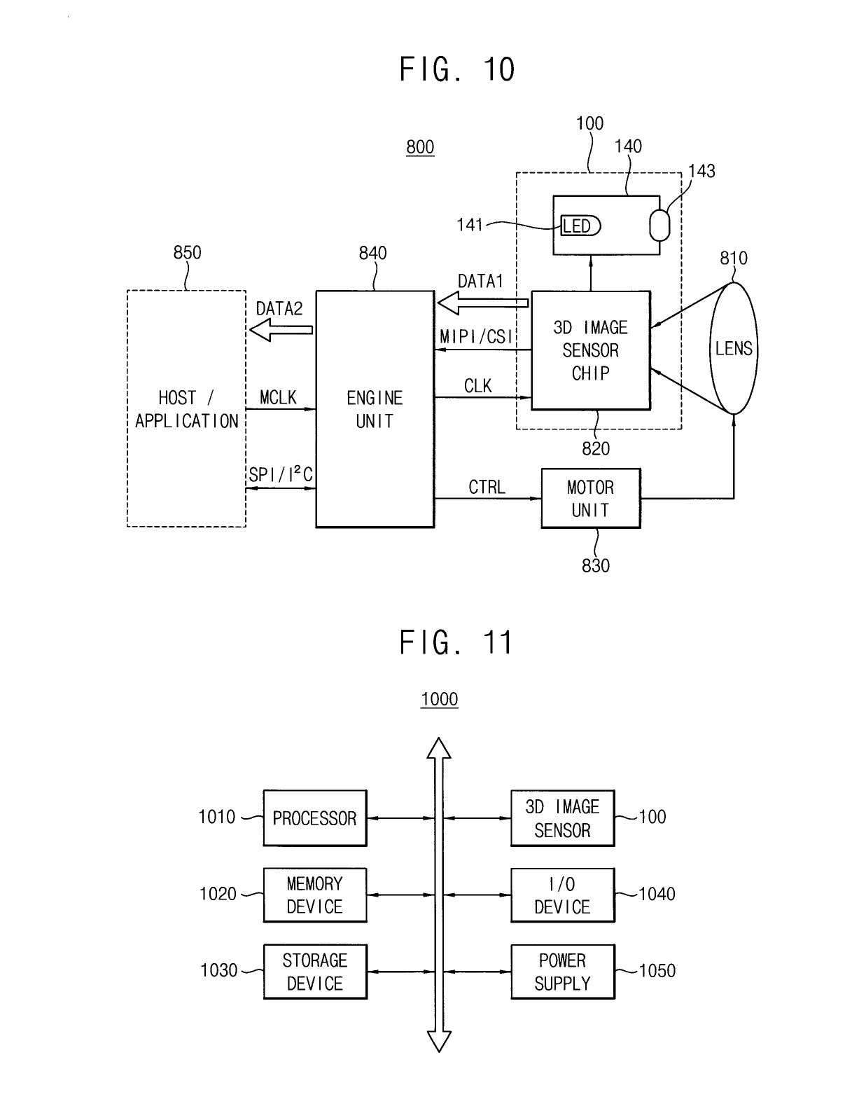

FIG. 10 is a block diagram illustrating a camera including a three-dimensional image sensor according to example embodiments.

Referring to FIG. 10, a camera 800 includes a receiving lens 810, a three-dimensional image sensor 100, a motor unit 830 and an engine unit 840. The three-dimensional image sensor 100 may include a three-dimensional image sensor chip 820 and a light source module 140. In some example embodiments, the three-dimensional image sensor chip 820 and the light source module 140 may be implemented as separate devices, or may be implemented such that at least one component of the light source module 140 is included in the three-dimensional image sensor chip 820.

The receiving lens 810 may focus incident light on a photo-receiving region (e.g., depth pixels and/or color pixels) of the three-dimensional image sensor chip 820. In a low power standby mode, the three-dimensional image sensor chip 820 may generate a two-dimensional image based on the incident light passing through the receiving lens 810, and may detect a position change of an object by analyzing the generated two-dimensional image. If the position change of the object is detected, the three-dimensional image sensor chip 820 may control the light source mode 140 to emit light with high luminance, may generate a three-dimensional image based on the incident light passing through the receiving lens 810, and may perform gesture recognition for the object by analyzing the generated three-dimensional image. Further, the three-dimensional image sensor chip 820 may provide data DATA1 about the two-dimensional image or the three-dimensional image to the engine unit 840.

The three-dimensional image sensor chip 820 may provide the data DATA1 to the engine unit 840 in response to a clock signal CLK. According to example embodiments, the three-dimensional image sensor chip 820 may interface with the engine unit 840 using a mobile industry processor interface (MIPI) and/or a camera serial interface (CSI).

The motor unit 830 may control the focusing of the lens 810 or may perform shuttering in response to a control signal CTRL received from the engine unit 840.

The engine unit 840 may control the three-dimensional image sensor 100 and the motor unit 830. The engine unit 840 may process the data DATA1 received from the three-dimensional image sensor chip 820. For example, the engine unit 840 may generate three-dimensional color data based on the received data DATA1. According to example embodiments, the engine unit 840 may generate YUV data including a luminance component, a difference between the luminance component and a blue component, and a difference between the luminance component and a red component based on the RGB data, or may generate compressed data, such as joint photography experts group (JPEG) data. The engine unit 840 may be coupled to a host/application 850, and may provide data DATA2 to the host/application 850 based on a master clock signal MCLK. According to example embodiments, the engine unit 840 may interface with the host/application 850 using a serial peripheral interface (SPI) and/or an inter integrated circuit (I2C) interface.

FIG. 11 is a block diagram illustrating a computing system including a three-dimensional image sensor according to example embodiments.

Referring to FIG. 11, a computing system 1000 includes a processor 1010, a memory device 1020, a storage device 1030, an input/output device 1040, a power supply 1050 and a three-dimensional image sensor 100. Although it is not illustrated in FIG. 11, the computing system 1000 may further include a port for communicating with electronic devices, such as a video card, a sound card, a memory card, a USB device, etc.

The processor 1010 may perform specific calculations and/or tasks. For example, the processor 1010 may be a microprocessor, a central process unit (CPU), a digital signal processor, or the like. The processor 1010 may communicate with the memory device 1020, the storage device 1030 and the input/output device 1040 via an address bus, a control bus and/or a data bus. The processor 1010 may be coupled to an extension bus, such as a peripheral component interconnect (PCI) bus. The memory device 1020 may store data for operating the computing system 1020. For example, the memory device 1020 may be implemented by a dynamic random access memory (DRAM), a mobile DRAM, a static random access memory (SRAM), a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), or the like. The storage device 1030 may include a solid state drive, a hard disk drive, a CD-ROM, or the like. The input/output device 1040 may include an input device, such as a keyboard, a mouse, a keypad, etc., and an output device, such as a printer, a display device, or the like. The power supply 1050 may supply power to the computing device 1000.

The three-dimensional image sensor 100 may be coupled to the processor 1010 via the buses or other desired communication links. As described above, the three-dimensional image sensor 100 may generate a two-dimensional image with low power consumption in a low power standby mode, and may switch a mode from the low power standby mode to a three-dimensional operating mode when a position change of an object is detected in the two-dimensional image. In the three-dimensional operating mode, the three-dimensional image sensor 100 may perform gesture recognition using light of high luminance. After the gesture recognition is completed, the three-dimensional image sensor 100 may return to the low power standby mode, thereby reducing power consumption. According to example embodiments, the three-dimensional image sensor 100 and the processor 1010 may be integrated in one chip, or may be implemented as separate chips.

According to example embodiments, the three-dimensional image sensor 100 and/or components of the three-dimensional image sensor 100 may be packaged in various desired forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

The computing system 1000 may be any computing system including the three-dimensional image sensor 100. For example, the computing system 1000 may include a digital camera, a mobile phone, a smart phone, a personal digital assistants (PDA), a portable multimedia player (PMP), a personal computer, a server computer, a workstation, a laptop computer, a tablet computer, a digital television, a set-top box, a music player, a portable game console, a navigation system, or the like.

Example embodiments may be used in any three-dimensional image sensor or any system including the three-dimensional image sensor, such as a digital camera, a three-dimensional camera, a mobile phone, a tablet computer, a personal digital assistant (PDA), a scanner, a navigator, a video phone, a monitoring system, an auto focus system, a tracking system, a motion capture system, an image stabilizing system, or the like.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A method of operating a three-dimensional image sensor including a light source module, comprising:
detecting a position change of an object by generating a two-dimensional image in a low power standby mode using the three-dimensional image sensor;
switching a mode of the three-dimensional image sensor from the low power standby mode to a three-dimensional operating mode when the position change of the object is detected in the two-dimensional image; and
performing gesture recognition for the object by generating a three-dimensional image using the light source module and the three-dimensional image sensor in the three-dimensional operating mode.

2. The method of claim 1, further comprising:
deactivating the light source module in the low power standby mode; and
activating the light source module in the three-dimensional operating mode.

3. The method of claim 1, further comprising:
emitting light from the light source module with relatively low luminance in the low power standby mode; and
emitting the light with relatively high luminance in the three-dimensional operating mode.

4. The method of claim 3, wherein the light emitted by the light source module is infrared light or near-infrared light.

5. The method of claim 1, wherein the performing the gesture recognition includes measuring a distance of the object from the three-dimensional image sensor and a horizontal movement of the object.

6. The method of claim 5, wherein the measuring the distance of the object from the three-dimensional image sensor is based on a time-of-flight of light that is emitted by the light source module and is reflected by the object back to the three-dimensional image sensor, the time-of-flight being an amount of time between transmission of the emitted light and receipt of the emitted light at the three-dimensional sensor after the emitted light is reflected from the object.

7. The method of claim 1, wherein the three-dimensional image sensor includes a plurality of depth pixels.

8. The method of claim 1, wherein the three-dimensional image sensor includes a plurality of color pixels and a plurality of depth pixels, and
wherein generating the two-dimensional image in a low power standby mode includes generating the two-dimensional image using the plurality of color pixels in the low power standby mode, and generating a three-dimensional image includes generating the three-dimensional image using the plurality of depth pixels in the three-dimensional operating mode.

9. The method of claim 1, wherein the three-dimensional image sensor includes a plurality of depth pixels, and
wherein the three-dimensional image sensor is configured such that the plurality of depth pixels are grouped into a plurality of pixel groups, and wherein generating the two-dimensional image in a low power standby mode includes generating the two-dimensional image based on output signals of the plurality of pixel groups.

10. The method of claim 9, further comprising:
determining sizes of the plurality of pixel groups according to distances of the plurality of pixel groups from a center of a field of view of the three-dimensional image sensor such that a number of the depth pixels included in each pixel group increases as a distance of the pixel group from the center of the field of view increases.

11. The method of claim 1, wherein the three-dimensional image sensor includes a plurality of depth pixels arranged in a matrix form having a plurality of rows and a plurality of columns, and
wherein the three-dimensional image sensor is configured to generate the two-dimensional image using the depth pixels in a portion of the plurality of rows.

12. A method of operating a three-dimensional image sensor including a light source module, comprising:
detecting, by the three-dimensional image sensor, a position change of an object by generating a two-dimensional image in a low power standby mode; and,
if the position change of the object is detected in the two-dimensional image,
switching a mode of the three-dimensional image sensor from the low power standby mode to a three-dimensional operating mode ;
performing, by the three-dimensional image sensor, gesture recognition for the object by generating a three-dimensional image using the light source module in the three-dimensional operating mode; and
switching the mode of the three-dimensional image sensor from the three-dimensional operating mode to the low power standby mode after the gesture recognition is completed.

13. The method of claim 12, wherein an integration time for generating the two-dimensional image in the low power standby mode is longer than an integration time for generating the three-dimensional image in the three-dimensional operating mode.

14. The method of claim 12, wherein the three-dimensional image sensor uses light of low luminance emitted by the light source module or ambient light to generate the two-dimensional image in the low power standby mode.

15. The method of claim 12, further comprising:
maintaining the mode of the three-dimensional image sensor as the low power standby mode, if the position change of the object is not detected.

16. A method of operating a three-dimensional image sensor, the method comprising:
detecting a change in a position of an object based on a two-dimensional image of the object captured by the three-dimensional image sensor operating in a low-power mode;
changing the low-power mode of the three dimensional image sensor to a high power mode based on the detecting, the high-power mode using more power than the low-power mode; and
performing three-dimensional gesture recognition based on a three-dimensional image of the object captured by the three-dimensional sensor operating in the high-powered mode.

17. The method of claim 16, wherein changing the low-power mode to the high-power mode includes activating a light source module which emits light on the object when activated.

18. The method of claims 16, further comprising:
changing the high-power mode to the low-power mode after movement of the object is no longer detected by the three-dimensional sensor.

19. The method of claims 18, wherein changing the high-power mode to the low-power mode includes deactivating a light source module which emits light on the object when activated.
